(19) United States
(12) Patent Application Publication
(10) Pub. No.: US 2026/0030447 A1
(43) Pub. Date: Jan. 29, 2026

(54) CONVERSION APPARATUS, CONVERSION METHOD, AND PROGRAM

(71) Applicant: NIPPON TELEGRAPH AND TELEPHONE CORPORATION, Tokyo (JP)

(72) Inventors: Yoko ISHII, Tokyo (JP); Momoko NAKATANI, Tokyo (JP); Harumi SAITO, Tokyo (JP)

(21) Appl. No.: 18/994,282

(22) PCT Filed: Jul. 26, 2022
(86) PCT No.: PCT/JP2022/028792

§ 371 Date: Jan. 14, 2025

(51) Int. Cl. G06F 40/274; G06F 3/01

(52) U.S. Cl. CPC G06F 40/274; G06F 3/011

(57) ABSTRACT

A conversion device includes a character conversion unit that converts input information into character information, a selection unit that selects character information to be displayed from one or more pieces of the character information obtained by the character conversion unit, and a coordinate conversion unit that converts the character information selected by the selection unit into coordinates corresponding to a display position of the character information.

### TECHNICAL FIELD

The present invention relates to a technology for displaying character information.

### BACKGROUND ART

In a dialogue with two or more participants, there is often a facilitator having a role of smoothly advancing the dialogue between the participants. In the dialogue in which the facilitator exists, the facilitator often proceeds the dialogue by posting sticky notes while grouping the sticky notes while taking note of utterance contents on the sticky notes. With such grouping, it is possible to easily grasp the relevance of the utterance contents, and thus, it is possible to smoothly advance the dialogue.

### CITATION LIST

### Non Patent Literature

Non Patent Literature 1: H. Masataki, D. Shibata, Y. Nakazawa, S. Kobashikawa, A. Ogawa, K. Ohtsuki, VoiceRex-Spontaneous speech recognition technology for contact-center conversations, NTT Tech. Rev., 5 (2007) 22-27.

### SUMMARY OF INVENTION

### Technical Problem

However, a high skill is required to advance a dialogue while grouping sticky notes, and it is particularly difficult for a beginner.

As a conventional technique related to display of utterance content of a person, a speech recognition system that automatically converts speech content of a person into text in real time is disclosed in Non Patent Literature 1. However, in the general speech recognition system disclosed in Non Patent Literature 1 and the like, it is difficult to read the relevance between a plurality of utterance contents from character information because only the utterance contents are displayed as character information.

Note that the above problem is not limited to the dialogue in which the facilitator exists, and is a problem that can occur in the entire dialogue scene in which utterance is performed by voice, character input, or the like.

The present invention has been made in view of the above points, and an object of the present invention is to provide a technique capable of displaying character information so that relevance between a plurality of utterance contents can be easily read from the character information.

### Solution to Problem

According to the disclosed technology, there is provided a conversion device including:
a character conversion unit that converts input information into character information;
a selection unit that selects character information to be displayed from one or more pieces of the character information obtained by the character conversion unit; and
a coordinate conversion unit that converts the character information selected by the selection unit into coordinates corresponding to a display position of the character information.

### Advantageous Effects of Invention

According to the disclosed technology, there is provided a technology capable of displaying character information so that relevance between a plurality of utterance contents can be easily read from the character information.

### BRIEF DESCRIPTION OF DRAWINGS

FIG. 1 is a diagram illustrating an overall configuration example of a visualization system.

FIG. 2 is a flowchart for describing an operation of the conversion device.

FIG. 3 is a diagram for describing coordinates on a display screen.

FIG. 4 is a diagram illustrating a display example.

FIG. 5 is a diagram illustrating a conversion device of Modification 1.

FIG. 6 is a diagram illustrating the conversion device of Modification 1.

FIG. 7 is a diagram illustrating a hardware configuration example of devices.

### DESCRIPTION OF EMBODIMENTS

Hereinafter, an embodiment of the present invention (the present embodiment) will be described below with reference to the drawings. The embodiment to be described below is merely exemplary and embodiments to which the present invention is applied are not limited to the embodiment to be described below.

In the following embodiment, there is assumed a dialogue in which there are two or more participants and a facilitator exists in order to smoothly advance a dialogue between the participants, and it is assumed that utterance content of the facilitator is summarized and displayed together with a subject.

However, the technology according to the present invention can be applied to a wide range of general dialogue scenes that are not limited to such an assumption. For example, with the technology according to the present invention, the utterance content of any person in a dialogue in which there is no facilitator can be displayed so that the relevance of the utterance content can be easily understood.

Further, in the embodiment described below, “sentence” is used as an example of character information to be displayed, but the character information to be displayed is not limited to “sentence”. The character information to be displayed may be a sentence, a word, a symbol, or other information.

### Outline of Embodiment

As described above, in a dialogue in which there are two or more participants and a facilitator exists in order to facilitate a dialogue between the participants, it is often performed that the facilitator writes out only important points, but a high skill of the facilitator is required to write out points while coordinating a dialogue place.

For this problem, for example, it is conceivable to automatically display all the utterance contents in characters using a conventional speech recognition system. However, in this method, it is difficult for the participants to read which point is important. In particular, in a case where the dialogue is performed over a long time, it is difficult for the participant to confirm the utterance content while organizing the utterance content in the head.

Therefore, in the present embodiment, when the facilitator just sequentially inputs utterance content (sentence) to a conversion device 100 by voice input, a keyboard, or the like, the conversion device 100 automatically calculates two-dimensional coordinates in which the summarized sentence is to be arranged so as to match the closeness of meaning between sentences (that is, in order to make the relevance between sentences clear).

Further, in view of the problem that high skill of the facilitator is required to extract the content of the discussion on the spot in an easy-to-understand manner, in the present embodiment, the conversion device 100 can determine the reaction of another person to the utterance content (sentence) uttered by the facilitator, and display the sentence having the characteristic reaction while preferentially leaving the sentence. That is, the sentence having a characteristic reaction is considered to represent the content of the discussion on the spot, and thus it can be said that the conversion device 100 can easily extract the content of the discussion on the spot.

### System Configuration Example

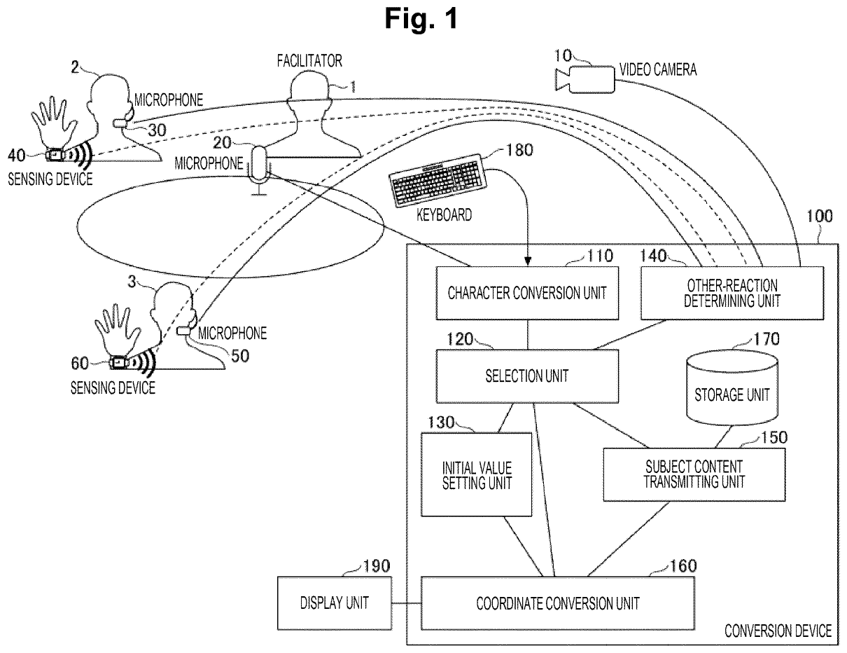

FIG. 1 illustrates a configuration example of a visualization system of the present embodiment. The visualization system according to the present embodiment is used in a scene where two or more persons are having a dialogue. In the example illustrated in FIG. 1, a situation in which three persons 1 to 3 participate in the dialogue is illustrated. Note that the configuration illustrated in FIG. 1 will be referred to as a “basic example”.

One of the three persons (person 1) is a facilitator having a role of smoothly advancing the dialogue among the participants.

The visualization system illustrated in FIG. 1 includes the conversion device 100, a video camera 10, microphones 20, 30, and 50, and sensing devices 40 and 60.

The conversion device 100 is, for example, a computer such as a personal computer (PC). In FIG. 1, as an example, a keyboard 180 and a display unit 190 (an information display function including a display) are connected to the conversion device 100. Note that the display unit 190 may be a functional unit constituting the conversion device 100.

In addition, the keyboard 180, the video camera 10, the microphones 20, 30, and 50, and the sensing devices 40 and 60 are all examples of input units for inputting information to the conversion device 10. Any input unit may be a functional unit constituting the conversion device 10.

As illustrated in FIG. 1, the conversion device 100 includes a character conversion unit 110, a selection unit 120, an initial value setting unit 130, an other-reaction determining unit 140, a subject content transmitting unit 150, a coordinate conversion unit 160, and a storage unit 170.

### (Operation Example of Conversion Device 100)

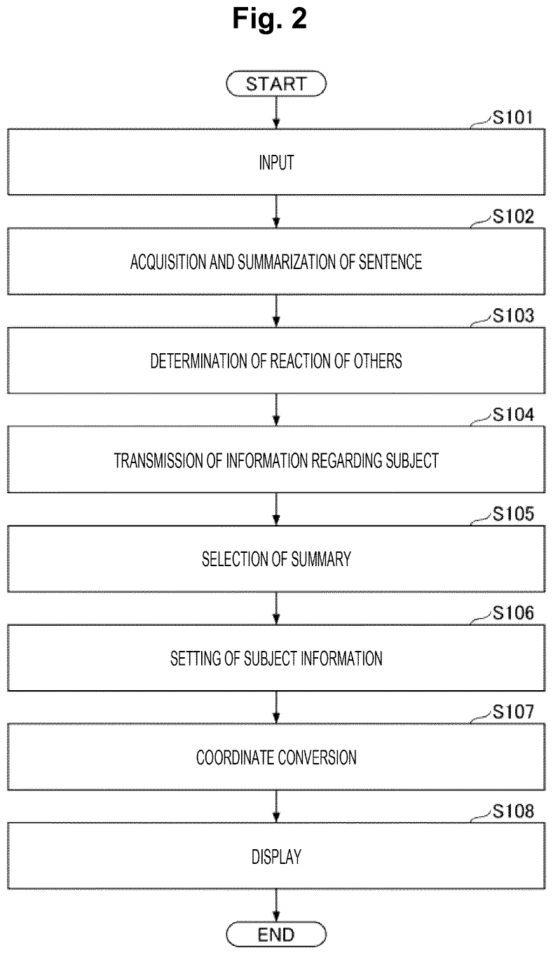

Next, an operation example of the conversion device 100 having the above-described configuration will be described along the procedure of the flowchart of FIG. 2. Note that the procedure illustrated in FIG. 2 is an example, and the operation of the conversion device 100 is not limited to the procedure of FIG. 2.

As a premise of the following operation, the initial value setting unit 130 receives in advance input of a period T (a period of 1 second or more), a numerical value a (an integer of 1 or more), and a size (displayX, displayY) of an area for displaying utterance content on the display unit 170, and holds the received information. For example, the keyboard 180 is used for the input here. Note that each unit of displayX and displayY is assumed to be a pixel.

### <S101: Input>

When the facilitator utters a voice, utterance information is input from the microphone 20 to the character conversion unit 110. In addition, when the facilitator inputs information using the keyboard 180, the input information is input to the character conversion unit 110.

### <S102: Acquisition and Summarization of Sentence>

In S102, the character conversion unit 110 converts the voice input from the microphone 20 into character information to acquire a sentence. Further, the character conversion unit 110 converts information (specifically, a sequence of signals such as a code) input from the keyboard 180 into a sentence.

Furthermore, the character conversion unit 110 performs summarization processing on the sentence acquired by the conversion to acquire a summary (summarized sentence) of the sentence. Any prior art may be used for summarizing a sentence. As an example, a sentence may be summarized using the technique disclosed in Japanese Unexamined Patent Application Publication No. 2011-28638.

In the above summary processing, the character conversion unit 110 counts the number of characters of the sentence, performs summarization so that the number of characters is equal to or less than a certain threshold value, and sends the summarized sentence (this may be referred to as “summary”) to the selection unit 120.

### <S103: Determination of Reaction of Others>

Next, processing related to the other-reaction determining unit 140 will be described. The other-reaction determining unit 140 is a functional unit that determines a reaction of a person other than the person who is speaking. In the present embodiment, it is assumed that a person who is performing an utterance that is a target of summary display is the facilitator (person 1), and the other-reaction determining unit 140 determines a reaction of a person other than the facilitator to the utterance of the facilitator.

The other-reaction determining unit 140 is connected with at least one of three types of devices including a video camera that captures the state of people who are having a dialogue, a microphone that collects utterances of the people who are having a dialogue, and a sensing device that senses the people who are having a dialogue. For example, the microphones and the sensing devices are prepared as many as the number of persons (excluding the facilitator) participating in the dialogue.

In the example illustrated in FIG. 1, the video camera 10 is provided, and the microphone 30 and the sensing device 40 for a person 2, and the microphone 50 and the sensing device 60 for a person 3 are provided.

In the visualization system according to the present embodiment, it is assumed that the conversion device 100, the video camera 10, the microphones 20, 30, and 50, and the sensing devices 40 and 60 are all synchronized in time. Hereinafter, each of an operation in a case where the video camera is provided, an operation in a case where the microphone is provided, and an operation in a case where the sensing device is provided will be described.

Note that the types of microphones 20, 30, and 50 may be any type, and for example, a headset microphone, a lavalier microphone, a gooseneck microphone, or the like can be used.

Furthermore, the types of the sensing devices 40 and 60 may be any type, and for example, a device in which at least one of a gyro sensor, a heart rate measuring device, or a brain wave sensor is built can be used as the sensing device.

### <Operation for Video Camera>

The video acquired by the video camera is input to the other-reaction determining unit 140, and the other-reaction determining unit 140 acquires position information of a skeleton of each person in real time from the video by using, for example, an API of a posture estimating service (for example, OpenPose).

The other-reaction determining unit 140 detects a motion such as a nodding motion, a neck swinging motion, and a forward tilting motion of a person from a time-series change in the position information of the skeleton of the person. The detection of the motion of the person by the other-reaction determining unit 140 may be performed on the basis of a positional relationship between certain skeletons or on the basis of a time-series change movement of one or more skeletons.

A plurality of motions is set to the other-reaction determining unit 140 as motions to be detected. In addition, a certain numerical value is set for each operation. When detecting a certain motion with respect to a certain person, the other-reaction determining unit 140 acquires a numerical value set for the motion as a weight α. The other-reaction determining unit 140 transmits the weight α acquired by the detection of the motion to the selection unit 120 together with time information t at which the motion has occurred.

In a case where the other-reaction determining unit 140 detects a plurality of actions at the same time t, a weight for each of the plurality of actions may be sent to the selection unit 120, any one action may be selected from the plurality of actions on the basis of a predetermined rule and a weight of the selected action may be sent to the selection unit 120, or a value obtained by adding respective weights for the plurality of actions may be sent to the selection unit 120.

### <Operation Regarding Microphone>

The voice of an utterance of each dialogue participant is input to the other-reaction determining unit 140 in real time by the microphone provided for each dialogue participant. The other-reaction determining unit 140 performs the following processing on the voice of each person.

The other-reaction determining unit 140 associates the voice of an acquired utterance with a numerical value representing intensity of emotion, for example, by using an emotion understanding engine of an existing technology.

In the other-reaction determining unit 140, a certain threshold and a numerical value corresponding to a case where a numerical value indicating the intensity of emotion exceeds (or falls below) the threshold are set in advance. The other-reaction determining unit 140 sets the numerical value for the intensity of emotion detected on the basis of a voice input from the microphone as the weight α. The other-reaction determining unit 140 sends the weight α obtained by detecting the intensity of emotion based on the voice to the selection unit 120 together with the time information t at which the utterance corresponding to the weight α has occurred.

Further, instead of acquiring and transmitting the weight α based on the emotion recognition as described above, or in addition to acquiring and transmitting the weight α based on the emotion recognition, the other-reaction determining unit 140 may acquire and transmit the weight α by the following processing.

One or more predetermined phrases such as “I know” and “Oh” are set in the other-reaction determining unit 140 in advance. In addition, a numerical value is set for each phrase, and the numerical value is set as a weight α. That is, in a case where a preset phrase is detected from an uttered voice, the other-reaction determining unit 140 sends a numerical value corresponding to the uttered voice as the weight α to the selection unit 120 together with the time information t.

The other-reaction determining unit 140 may perform either or both of weight calculation based on a numerical value of the intensity of emotion and weight calculation based on a phrase. In the case of performing both, each weight α may be sent to the selection unit 120 together with the time information t, one of the weights may be selected on the basis of a predetermined rule and sent to the selection unit 120 together with the time information t, or a value obtained by adding both weights may be sent to the selection unit 120 together with the time information t as the weight α.

### <Operation for Sensing Device>

Sensing information (output data of the sensing device) of each dialogue participant is input to the other-reaction determining unit 140 in real time by a sensing device provided for each dialogue participant. The other-reaction determining unit 140 performs the following processing on the sensing information of each person.

One sensing device may be provided for each person, or a plurality of different types of sensing devices may be provided. The other-reaction determining unit 140 detects a certain preset feature from output data of each sensing device.

In the other-reaction determining unit 140, a plurality of features and numerical values for each feature are set in advance. The other-reaction determining unit 140 acquires a numerical value corresponding to a detected feature as the weight α. The other-reaction determining unit 140 sends the weight α acquired on the basis of detection of a certain feature to the selection unit 120 together with the time information t at which the feature has occurred.

Although the above “feature” may be of any type, for example, detection of a state in which a value of the sensing information exceeds (or falls below) a preset threshold may be regarded as detection of a feature, or detection of a predetermined change from a time-series change of sensing data may be regarded as detection of a feature.

In a case where the other-reaction determining unit 140 detects a plurality of features, a weight for each of the plurality of features may be sent to the selection unit 120, any one feature may be selected from the plurality of features on the basis of a predetermined rule and a weight of the selected feature may be sent to the selection unit 120, or a value obtained by adding respective weights for the plurality of features may be sent to the selection unit 120.

### <S104: Transmission of Information Regarding Subject>

In S104, the subject content transmitting unit 150 transmits, to the coordinate conversion unit 160 and the selection unit 120, a sentence of a subject registered in the storage unit 170 in advance and a time s during which the facilitator talks about the subject. When a new subject is added to the storage unit 170, the subject content transmitting unit 150 transmits the sentence of the added subject and the time s for talking about the subject to the coordinate conversion unit 160 and the selection unit 120. Note that the “subject” may be rephrased as a “topic”, a “theme”, a “topic”, or the like.

Note that when the subject and the time s are stored in the storage unit 170, the subject and the time s are stored together with a number for identifying the subject. In addition, regarding the subject to be transmitted to the selection unit 120, the information to be transmitted may be numbers for identifying the sentence of the subject and the subject, or may be only a number for identifying the subject.

Note that the sentence or the like of the subject and the time s during which the facilitator talks about the subject may be transmitted only to the coordinate conversion unit 160 and not to the selection unit 120.

### <S105: Selection of Summary>

In S105, the selection unit 120 receives a summary of a sentence from the character conversion unit 110. As described above, the summary is a summary of a sentence input as a voice or a character by the facilitator. In the summary, the start time and the end time of the utterance corresponding to the summary are set. Note that the meaning of “utterance” includes not only utterance of a voice but also input with a keyboard.

The selection unit 120 sequentially receives summaries from the character conversion unit 110. That is, during a certain period, the selection unit 120 receives a plurality of summaries from the character conversion unit 110. However, during a certain period, the selection unit 120 may receive only one summary from the character conversion unit 110.

Upon receiving the weight α and the time information t from the other-reaction determining unit 140, in a case where there is a summary corresponding to the time including the received time information t, the selection unit 120 associates the value of the weight α received together with the time information t with the summary. For example, assuming that the start time to the end time of the summary are T to T+10 and the time information t received together with the weight α is T+5, the weight α is associated with the summary.

Note that a period “start time to end time+nt” obtained by adding a time nt to be described later to the end time of the period “start time to end time” of the summary may be used for determination. In this case, upon receiving the weight α and the time information t from the other-reaction determining unit 120, in a case where the received time information t is included in “start time to end time+nt”, the selection unit 120 associates the value of the weight α received together with the time information t with the summary.

In a case where a plurality of weights a corresponds to the same summary, the selection unit 120 sets a sum of all the weights a as the weight of the summary.

Regarding the time after the end time of the summary, the selection unit 120 receives information from the other-reaction determining unit 140 only for a predetermined time nt from the end time of the summary, and discards information received at the time after that.

The time nt is managed by the selection unit 12, and even if the time information t sent from the other-reaction determining unit 140 is actually within the “start time to end time+nt”, in a case where “end time+nt” has elapsed at the time of receiving it, the received information is discarded. However, such processing is an example.

Further, in a case where the selection unit 12 does not receive information regarding the corresponding summary from the other-reaction determining unit 140 even after the “end time+nt” elapses, the weight of the summary is set to 0.

The selection unit 120 receives the period T and the value of the numerical value a from the initial value setting unit 130, and selects a number a of summaries summarized during the period T as summaries to be candidates for display on the basis of a predetermined rule. Examples of the selection rule are as follows. Note that the summary summarized during the period T is, for example, a summary in which “start time to end time” is included in the period T. Note that, when the a summaries do not exist as a summary summarized during the period T, it is sufficient if all the summaries summarized during the period T are selected.

The selection unit 120 first selects summaries in descending order of the numerical values of the weights set for the summaries, and then selects a summaries in ascending order of the start time of the utterance. For example, it is assumed that there are summary 1 (start time t, weight 5), summary 2 (start time t−1, weight 4), summary 3 (start time t+1, weight 6), and summary 4 (start time t−1, weight 3), and a=3 is set.

At this time, the selection unit 120 selects summary 3 (start time t+1, weight 6), summary 1 (start time t, weight 5), and summary 2 (start time t−1, weight 4) on the basis of the weight.

Further, assuming that there are summary 1 (start time t, weight 5), summary 2 (start time t−1, weight 4), summary 3 (start time t+1, weight 4), and summary 4 (start time t−2, weight 4), in a case where a=3 is set, the selection unit 120 first selects (start time t, weight 5), and selects, for those having the same weight, summary 4 (start time t−2, weight 4) and summary 2 (start time t−1, weight 4) on the basis of the start time.

### <S106: Setting Subject Information>

Next, the selection unit 120 sets the subject information as to which subject the speech was made for each selected summary. For example, on the basis of the subject received from the subject content transmitting unit 150 and the time s, the selection unit 120 sets the subject in the summary summarized within the time s. The information of the subject set in the summary is, for example, a number that can identify the subject. Note that determination as to whether the summary is summarized within the time s can be implemented, for example, by including time information (example: information that time s is a time from time a to time b) in the “time s”.

In addition, in a case where the facilitator is speaking about the subject registered in the storage unit 170, the facilitator may select the currently spoken subject using the keyboard 180 or the like as the dialogue progresses, and when the subject is switched, the facilitator may also select the subject again. While a subject is selected by the facilitator (until re-selection), the number of the subject is set in the summary of the contents uttered.

It is also possible for the facilitator or another person to set a new subject during the dialogue. In this case, the facilitator inputs a subject by manual input or voice input using an input device such as a keyboard or a microphone, and registers the subject in the storage unit 170. When a new subject is registered, the storage unit 170 assigns a number to the new subject, and information such as the number is returned from the subject content transmitting unit 150 to the selection unit 120. The selection unit 120 sets the number of the subject in the summary of the utterance of the subject.

The summary selected by the selection unit 150 is sent to the coordinate conversion unit 160 together with the number of the subject corresponding to the summary.

### <S107: Coordinate Conversion>

In S107, the coordinate conversion unit 160 receives the summary and the number of the subject from the selection unit 120.

First, the coordinate conversion unit 160 converts each summary into high-dimensional coordinates (high-dimensional vector). Any method may be used as a method of converting the sentence of the summary into high-dimensional coordinates, and for example, doc2vec or fast2text can be used. The high-dimensional coordinates obtained here are also called distributed representation, and indicate the feature amount of the summary. Both doc2vec and fast2text are examples of a conversion model for extracting a feature amount from character information such as a sentence.

The number of dimensions of the high-dimensional coordinates is, for example, 200 or the like. Any numerical value can be designated for the number of dimensions.

The coordinate conversion unit 160 performs dimensional compression by performing principal component analysis on coordinates converted from the summary, thereby obtaining two-dimensional coordinates (aX, aY). The two-dimensional coordinates (aX, aY) also indicate the feature amount of the summary.

Next, the coordinate conversion unit 160 sends the number of the subject received together with the summary to the storage unit 170, and checks whether the coordinates are registered for the subject. When the coordinates are registered in the storage unit 170, (titlex′, titleY′) that are center coordinates of a rectangular area corresponding to the subject and (summaryX, summaryY) representing the size of the area are acquired from the storage unit 170.

In a case where the coordinates are not registered in the storage unit 170, the coordinate conversion unit 160 executes the following coordinate conversion processing. The coordinate conversion unit 160 receives the sentence of the subject corresponding to the inquired subject number and the time s for talking about the subject from the storage unit 170, and performs the next processing.

Similarly to the coordinate conversion for the summary, the coordinate conversion unit 160 converts the subject sentence into high-dimensional coordinates, for example, using doc2vec or fast2text, and performs dimensional compression by performing the principal component analysis on the converted coordinates, thereby obtaining two-dimensional coordinates (titlex, titleY).

Next, the coordinate conversion unit 160 receives the size displayX, displayY of the rectangular area for displaying the dialogue content (utterance content) on the display unit 190 from the initial value setting unit 130. As described above, the units of displayX, displayY are pixels.

The coordinate conversion unit 160 projectively converts the coordinates (titlex, titleY) of the subject into the size of the area for displaying the dialogue content, and obtains coordinates (titlex′, titleY′).

Next, the coordinate conversion unit 160 obtains, from the storage unit 170, a time sn (s1 for one with the number of the subject is 1, . . . , sn for one with the number of the subject is n), the period T, and the numerical value a for talking about the subject for all the subjects scheduled to be discussed this time. Note that, here, it is assumed that the period T and the numerical value a are held in the storage unit 170.

The coordinate conversion unit 160 calculates (sn/T)×a=numM for each of all the subjects 1 to n, and sets numM as a maximum value of the number of final summaries related to the subject. numM corresponds to the number obtained by proportionally dividing a by the subject time sn with respect to the period T.

Next, the coordinate conversion unit 160 calculates ΣnumM_i (i=n)=NUMMAX and obtains the sum (NUMMAX) of summary maximum values of all the subjects. “ΣnumM_i (i=n)” is the sum of the subjects of numM.

Next, the coordinate conversion unit 160 calculates (displayX×displayY)/NUMMAX=area, and obtains a unit area for the summary maximum sum NUMMAX. Subsequently, the coordinate conversion unit 160 calculates numM×area=areaM for each subject, and sets this as a maximum area size areaM of each subject.

Next, the coordinate conversion unit 160 sets the shape of the arrangement area of the summary for each subject as a rectangle having the same ratio as displayX, displayY, and sets the sizes thereof as summaryX, summaryY. Specifically, the coordinate conversion unit 160 obtains summaryX, summaryY that satisfy summaryX×summaryY=areaM and displayX: displayY=summaryX: summaryY.

As a result of the above processing, the coordinate conversion unit 160 obtains values of (titlex′, titleY′) and values of (summaryX, summaryY) for each subject. Subsequently, the coordinate conversion unit 160 performs the following processing for each subject and each summary.

The coordinate conversion unit 160 projectively converts the two-dimensional coordinates (ax, aY) of the summary into summaryX, summaryY, and obtains (aX′, aY′).

Then, the coordinate conversion unit 160 performs conversion on (aX′, aY′) so that (titlex′—summaryX/2, titleY′—summaryY/2) is the origin, using the following equation, and obtains (ax″, aY″).

$${aX}^{″} = {aX}^{′} + ( {titleX}^{′} - summaryX / 2 ) \\ {aY}^{″} = {aY}^{′} + ( {titleY}^{′} - summaryY / 2 )$$

The coordinate conversion unit 160 transmits each piece of coordinate information including the obtained (aX″, aY″) and information such as the summary to be displayed to the display unit 190.

### <S108: Display>

The display unit 190 displays the sentence of the summary at the position of (aX″, aY″) for each subject and each summary. Further, the display unit 190 displays the subject at (titlex′, titleY′) for each subject. Note that, when the subject is already displayed, the subject is not overwritten.

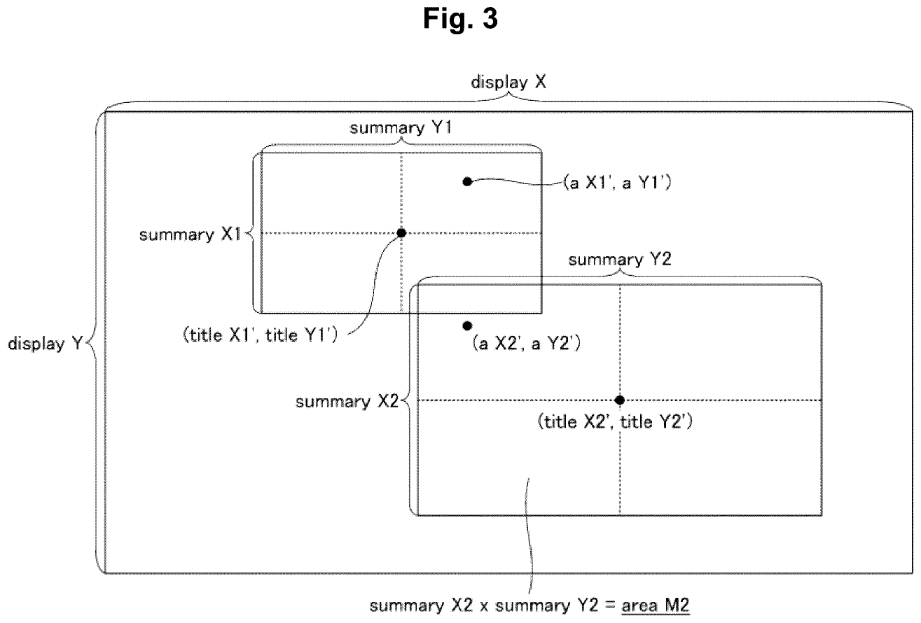

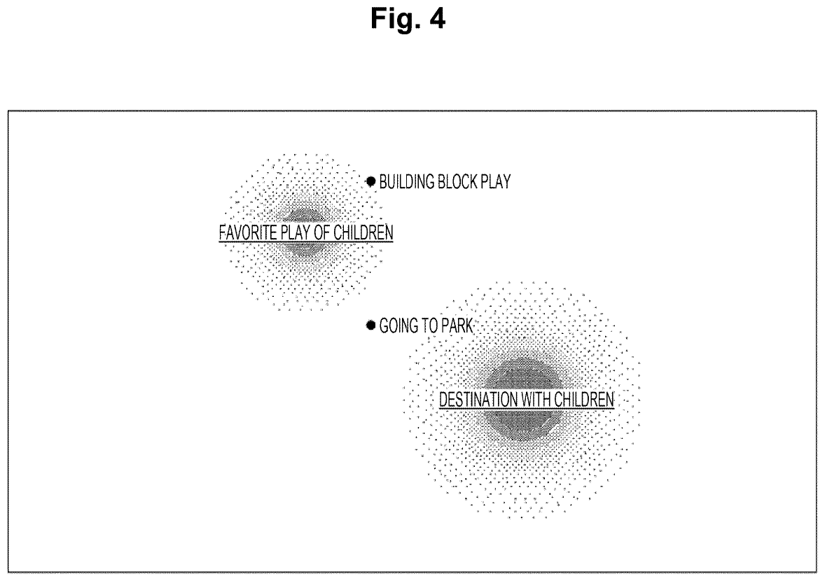

FIG. 3 illustrates an image of each coordinate. In FIG. 3, in the area of displayX×displayY, summaryX1×summaryY1 and summaryX2×summaryY2 which are summary display areas for two subjects are illustrated. Further, a display position (titleX1′, titleY1′) of a subject 1 and a display position (titleX2′, titleY2′) of a subject 2, and a display position (aX1′, aY1′) of a summary 1 and a display position (aX2′, aY2′) of a summary 2 are illustrated. Further, FIG. 4 illustrates a display example in a case where the above subject 1 is “favorite play of children”, the summary 1 is “building block play”, the subject 2 is “destination with children”, and the summary 2 is “going to a park”.

In addition, in order to clarify a “rectangle of (summaryX, summaryY) centered on (titlex′, titleY′)” which is an area of each subject, as illustrated in FIG. 4, a color may be applied to a circular shape centered on (titlex′, titleY′) to make the area of the subject easy to understand.

As described above, providing an area of the “rectangle of (summaryX, summaryY) centered on (titleX′, titleY′)” for each subject is an example, and the subject and the summary may be arranged (displayed) without providing such an area.

### (Modification 1)

In the configuration (basic example) of the conversion device 100 illustrated in FIG. 1, the other-reaction determining unit 140 may not be provided. In this case, each microphone and each sensing device attached to the persons 2 and 3 other than the video camera 10 and the facilitator may not be provided. However, the persons 2 and 3 may include the microphones 30 and 50, and the voices from the microphones 30 and 50 may be input to the character conversion unit 110.

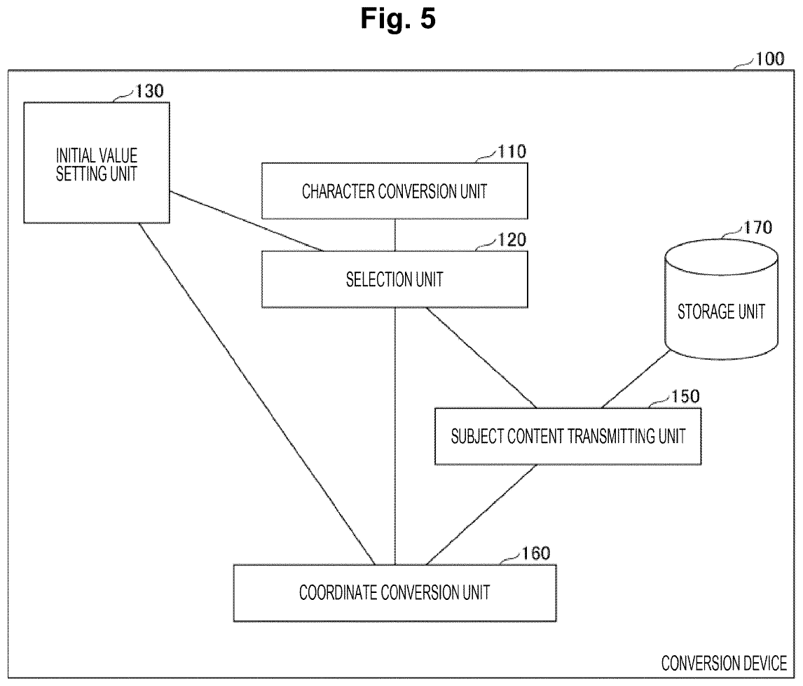

FIG. 5 illustrates a configuration of the basic example (conversion device 100 in FIG. 1) excluding the other-reaction determining unit 140. The operation of the conversion device 100 of Modification 1 illustrated in FIG. 5 corresponds to an operation obtained by excluding the operation related to the other-reaction determining unit 140 from the operation in the basic example.

As described above, in the basic example, the other-reaction determining unit 140 calculates the weight indicating the reaction of the other person, and the selection unit 120 selects the summary to be displayed from the plurality of summaries using the weight.

On the other hand, in Modification 1, since the weight is not calculated, the selection unit 120 selects a plurality of summaries from among the plurality of summaries received from the character conversion unit 110, for example, in order from one with an earlier start time of the utterance. In addition, the selection unit 120 may randomly select a plurality of summaries from the plurality of summaries received from the character conversion unit 110.

### (Modification 2)

In both the basic example and Modification 1, the subject may not be used. In this case, for example, the summary is displayed at the coordinates (aX′, aY′) for each summary without displaying the subject on the display unit 190. Even when the subjects are not displayed, summary contents of close meanings can be viewed together because each summary is displayed at a position corresponding to the closeness of the meanings. That is, the relevance between the summaries can be clearly displayed.

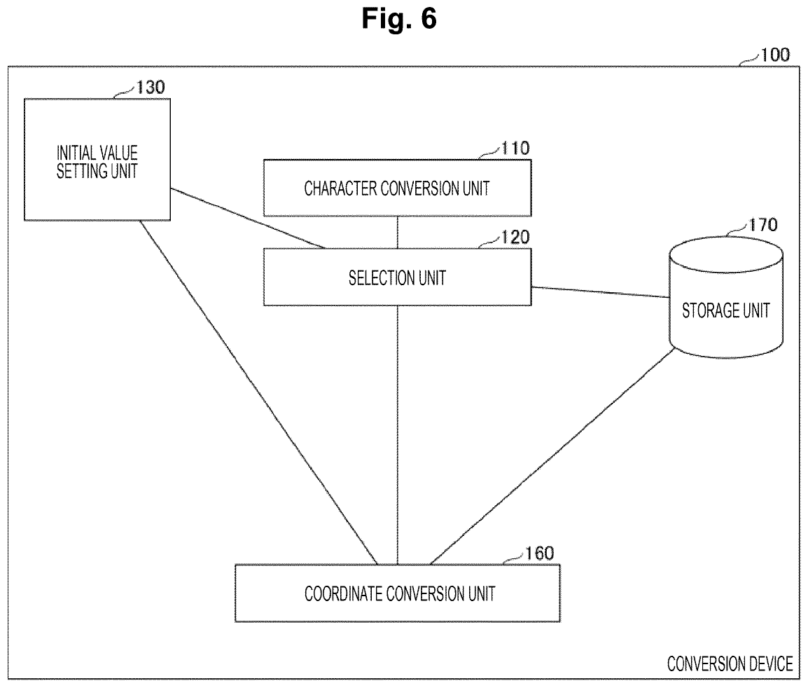

In Modification 2, since the subject is not used, the subject content transmitting unit 150 is unnecessary. FIG. 6 illustrates a configuration example of the conversion device 100 according to Modification 2. The operation of the configuration of FIG. 6 is an operation obtained by removing the operation related to the subject from the operation of Modification 1 (operation obtained by removing the operation of the other-reaction determining unit 140 from the basic example).

### Hardware Configuration Example

The conversion device 100 can be implemented by, for example, causing a computer to execute a program. This computer may be a physical computer, or may be a virtual machine on a cloud.

That is, the conversion device 100 can be implemented by a program corresponding to processing performed by the conversion device 100 being executed by use of hardware resources such as a CPU and a memory built in the computer. The above-described program can be stored and distributed by being recorded on a computer-readable recording medium (portable memory, and the like). Furthermore, the program can also be provided via a network such as the Internet or an electronic mail.

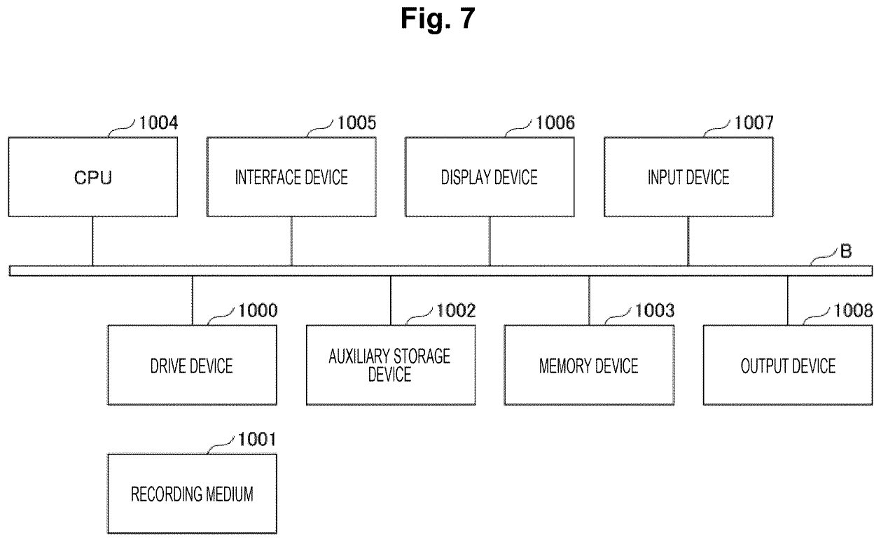

FIG. 7 is a diagram illustrating a hardware configuration example of the above computer. The computer in FIG. 7 includes a drive device 1000, an auxiliary storage device 1002, a memory device 1003, a CPU 1004, an interface device 1005, a display device 1006, an input device 1007, and an output device 1008, which are connected to one another by a bus BS.

A program for implementing processing in the computer is provided through a recording medium 1001 such as a CD-ROM or a memory card, for example. When the recording medium 1001 storing the program is set in the drive device 1000, the program is installed from the recording medium 1001 to the auxiliary storage device 1002 via the drive device 1000. However, the program is not necessarily installed from the recording medium 1001, and may be downloaded from another computer via a network. The auxiliary storage device 1002 stores the installed program, and also stores necessary files, data, and the like.

In a case where an instruction to start the program is given, the memory device 1003 reads the program from the auxiliary storage device 1002 and stores the program. The CPU 1004 implements a function related to the conversion device 100 in accordance with the program stored in the memory device 1003.

The interface device 1005 is used as an interface for connection to a network or the like. The display device 1006 displays a graphical user interface (GUI) or the like according to the program. The input device 1007 is configured with a keyboard and a mouse, a button, a touch panel, or the like, and is used to input various operation instructions. The output device 1008 outputs a calculation result. Note that, in a case where the conversion device 100 does not include the input unit and the display unit, the display device 1006 and the input device 1007 are not included in the computer.

### Summary and Effects of Embodiments

As described above, in the technology according to the present embodiment, it is possible to display character information so that the relevance between a plurality of utterance contents can be easily read from the character information.

More specifically, since the conversion device 100 can display a sentence input by the facilitator in a state of being automatically arranged in a two-dimensional space, the participants of the dialogue can view a plurality of summaries having similar meanings together. This has the effect that the cognitive load of the reading can be reduced.

Furthermore, since a sentence having a characteristic reaction can be preferentially left by the conversion device 100 including the other-reaction determining unit 140, it is possible to confirm the dialogue content in consideration of the reaction of the participant.

### (Supplementary Note)

The present specification discloses at least a conversion device, a conversion method, and a program described in each of the following items.

### (Supplementary Note 1)

A conversion device including:
a memory; and
at least one processor connected to the memory; and
the processor
converts input information into character information; and
selects character information to be displayed from one or more pieces of the obtained character information; and
converts the selected character information into coordinates corresponding to a display position of the character information.

### (Supplementary Note 2)

The conversion device according to supplementary note 1, in which
the processor converts the character information into high-dimensional coordinates using a conversion model, and performs dimension reduction on the high-dimensional coordinates to acquire the coordinates.

### (Supplementary Note 3)

The conversion device according to supplementary note 1 or 2, in which
the processor converts a topic corresponding to the character information selected by the selection unit into coordinates corresponding to a display position of the topic, and
on a display unit, the topic is displayed at coordinates obtained from the topic, and the character information is displayed at coordinates converted from the character information selected by the selection unit.

### (Supplementary Note 4)

The conversion device according to any one of supplementary notes 1 to 3, in which
the processor detects a reaction to the input information of a second person different from a first person who is a generation source of the input information.

### (Supplementary Note 5)

The conversion device according to supplementary note 4, in which
the processor converts the reaction into a weight, and selects character information to be displayed on a basis of a weight from the one or more pieces of weighted character information.

### (Supplementary Note 6)

A conversion method executed by a computer, the method including:
a character conversion step of converting input information into character information;
a selection step of selecting character information to be displayed from one or more pieces of the character information obtained by the character conversion step; and
a coordinate conversion step of converting the character information selected by the selection step into coordinates corresponding to a display position of the character information.

### (Supplementary Note 7)

A non-transitory storage medium that stores a program for causing a computer to function as each unit in the conversion device according to any one of supplementary notes 1 to 5.

Although this embodiment has been described above, the present invention is not limited to such a specific embodiment, and various modifications and changes can be made within the scope of the gist of the present invention described in the claims.

### REFERENCE SIGNS LIST

10 Video camera
20, 30, 50 Microphone
40, 60 Sensing device
100 Conversion device
110 Character conversion unit
120 Selection unit
130 Initial value setting unit
140 Other-reaction determining unit
150 Subject content transmitting unit
160 Coordinate conversion unit
170 Storage unit
180 Keyboard
190 Display unit
1000 Drive device
1001 Recording medium
1002 Auxiliary storage device
1003 Memory device
1004 CPU
1005 Interface device
1006 Display device
1007 Input device
1008 Output device

1. A conversion apparatus comprising:
circuitry configured to:
convert input information into one or more pieces of character information;
select target character information to be displayed from the one or more pieces of character information; and
convert the target character information into first coordinates corresponding to a display position of the target character information.

2. The conversion apparatus according to claim 1, wherein the circuitry is configured to:
convert the target character information into high-dimensional coordinates, using a conversion model; and
perform dimension reduction on the high-dimensional coordinates to acquire the first coordinates.

3. The conversion apparatus according to claim 1, wherein the circuitry is configured to:
convert a topic corresponding to the target character information into second coordinates in association with the topic; and
display, on a display device, the topic at the second coordinates in association with the topic, and the target character information at the first coordinates that are obtained by conversion from the target character information.

4. The conversion apparatus according to claim 1, wherein the circuitry is configured to detect a reaction to the input information from a second person different from a first person who is a source of the input information.

5. The conversion apparatus according to claim 4, wherein the circuitry is configured to:
convert the reaction into a weight; and
select, from the one or more pieces of character information that are weighted, the target character information to be displayed, based on the weight.

6. A conversion method executed by a computer, the conversion method comprising:
converting input information into one or more pieces of character information;
selecting target character information to be displayed from the one or more pieces of character information; and
converting the target character information into coordinates corresponding to a display position of the target character information.

7. A non-transitory computer readable storage medium storing a program configured for causing a computer to execute the conversion method of claim 6.
